(19) United States
(12) Patent Application Publication
(10) Pub. No.: US 2008/0209707 A1
(43) Pub. Date: Sep. 4, 2008

(54) Method for Attaining a Predetermined Clamping Force in Threaded Joints

(76) Inventors: Rubens Cioto, Sorocaba (BR); Andre Renato Collares, Sorocaba (BR); Cesar Henrique Zuffo, Sorocaba (BR)

Correspondence Address: SUGHRUE MION, PLLC, 2100 PENNSYLVANIA AVENUE, N.W., SUITE 800, WASHINGTON, DC, 20037, US

(21) Appl. No.: 11/917,520

(22) PCT Filed: Aug. 24, 2006
(86) PCT No.: PCT/BR06/00170

§ 371 Date: Dec. 14, 2007

(30) Foreign Application Priority Data
Sep. 5, 2005 (BR) PI0504490

(51) Int. Cl. B25B 23/14; G01L 5/24

(52) U.S. Cl. 29/407.02; 73/862.24; 702/41

(57) ABSTRACT

METHOD FOR ATTAINING A PREDETERMINED CLAMPING FORCE IN THREADED JOINTS through the employment of a plurality of equations and graphs converted into digital data and applied to a system of intelligent monitoring, being part of a computer program or specific software dedicated to operate manual or automatic spindle machines, the needed parameters being measured at the axle of the equipment connected to the wrench that acts over a threaded fastener, such as a bolt, nuts or equivalent element during the fastening operation, the acquisition of the data for calculation and utilization the variable “torsion angle” θ, θₜ and θₜ′″ occurring in real time during the operation of pretightening untightening and retightening performed by the spindle, said “torsion angle” θ, θₜ and θₜ′″ being extracted from parameters of torque and displacement necessary to obtain the clamping force of the jointed parts (plates and fastener) that are acting cooperatively during the tightening operation, said torsion angle θ, θₜ and θₜ′ taking into consideration many geometrical features of the threaded elements as well as their shearing modulus.

### FIELD OF THE INVENTION

The present invention refers to a method applied in automatic or manual spindles provided with means of measuring in real time the torque and the angle of displacement in association to the angles of torsion in order to determine the parameters that allow the tightening each threaded fastener to a predetermined clamp load, both in the elastic zone and in the plastic zone of the stress-strain curve during the initial operation of pretighten untighten and retighten on elastic zone of the threaded fastener from type bolts, nuts or internal counter thread in blind hole or through hole and correlatives seeking to obtain parameters that allow to tighten threaded fastener with its tensile force predetermined, through by torque or angle control on elastic or plastic zone; ditto method seeks, particularly, to be applied in conventional equipments of tightening, once that it obtains information that will be utilized for the final tighten of the threaded fastener reaching a prechosen force, on elastic and plastic zone by controlling of the torque or angle, allowing in this way, that any size of the threaded fastener lot's, few set of ten pieces to millions of units to be tightened on continuous assembly line have its final tighten individually determined through from individuals characteristics obtained during each individual operation of tightening (pretighten, untighten and retighten) allowing that the final tighten reaches a predetermined clamp load with high precision as on elastic zone as on plastic zone.

### BACKGROUND OF THE INVENTION

Nowadays productivity and quality are key words to those who want to be competitive. To reach this aim, it is necessary to rationalize and control the production systems.

Many are the industrial segments that employ manual or automatic equipments for tightening fasteners in assembly lines, such as for example the ones used by automotive industry, mainly in the assembly of the front axle, rear axle and other components as engine, gear box and so forth.

Special and dedicated equipments for laboratory measurements are also known, said equipments measuring axial force, applied torque, head/nut torque, threaded torque, rotation angle and linear elongation. Such information can be used in quality control as well as in research and development related to fasteners and bolted joints.

However, the data and parameters resulting from these laboratory measurements refer to the average features of a randomly chosen sample of a limited quantity of items, selected from a universe of thousands or even millions of parts. Therefore, the resulting clamping forces in the real-world assembly lines may show a substantial scattering of values, due to the fact that the individual characteristics of the fasteners have not been taken into consideration. In other words, the information obtained in laboratory tests does not guarantee that every threaded fastener will have the same characteristics that could result in high precision tightening operations.

The existing equipments used to tighten threaded fasteners are capable of “plotting” electronically the torque/angle relationship in real time, i.e. said angle comprising the rotation of the bolt or nut referred to a fixed point.

Said torque/angle relationship can be related to the clamping force, when the thread pitch and the resilience of the joint components (bolt, stud or nut as well as the plates being joined) are taken into consideration proportionality of this angle in relationship to the clamp load of tightening happens in function of the thread pitch and the fastener resilience (bolt, stud,) as well in function of the resilience of the plates that are being tightened. The formula (1), below, expresses this phenomenon in mathematical form:

$$α = \frac{360}{p} ( {δ}_{s} + {δ}_{p} ) {F}_{M} \qquad ( 1 )$$

Where:

α=Fastener rotation angle

δₛ=Fastener resilience

δₚ=Tightened plates resilience (Joint's resilience)

p=Thread pitch

F_{M}=Assembly force

For a better understanding it is said that the parameters of the clamping load takes into account the thread pitch and the fastener resilience and the plates, i.e., there is a relationship of proportionality between the angle of displacement of the head of the bolt or nut and the clamping force.

There have been several documents that use the above mentioned relationships for the execution of threaded joints. The following ones are the most representative of the usual known methods.

U.S. Pat. No. 4,375,121 (Sigmund, J. A.), issued May 1, 1983, named Dynamic friction indicator and tightening system usable therewith discloses a system for determining the friction coefficient of a threaded joint assembly, an apparatus for tightening a threaded joint assembly to a desired preload, a method of determining the friction coefficient of a threaded joint assembly and a method of tightening a joint assembly.

The method starts with the determination of the “tension rate” TR of the assembly, which is calculated by means of the formula

TR=(P_{E}−P_{L})/(θ_{E}−θ_{L}) (I)

where

P_{L} is the established induced load (preload) at an angle θ_{L};

P_{E} is the induced load at an angle θ_{E}.

Following, the slope M of the linear portion of the tightening curve (torque×angle) is calculated using the expression

M=dT/dθ (II)

This slope is then used to calculate the “coefficient of friction” C₁ of the joint assembly by means of the formula

C₁=M/[d(TR)] (III)

where d is the pitch diameter of the fastener.

Finally, the final torque T_{F} necessary to produce the desired preload P_{D} is calculated using the formula

T_{F}=C₁d(P_{E}−P_{L})+T_{L} (IV)

It should be remarked that P_{E} is defined in this document as “the induced load at some point less than the elastic limit of the joint assembly (not shown)”. As such, it is a preload value which cannot be measured directly with the apparatus shown in FIG. 2 of said patent document.

Moreover, the formulae used in this reference do not take into consideration the elasticity values of the joint and of the fastener. The method described in this document does not include any control or checking steps.

U.S. Pat. No. 5,284,217 (Eshghi, S.), issued Feb. 8, 1994, named Apparatus for tightening threaded fasteners based upon a predetermined torque-angle specification window title refers to an “apparatus”, however the object described in this patent consists of a method, because said apparatus had already been described in previous documents D1 and D2.

This reference describes a method to tighten a fastener to any desired proportion of the way through a torque-angle window defined by low and high angle limits and low and high torque limits.

The slope of the torque×angle curve for each joint assembly is calculated based on measurements carried out during the tightening operation and before reaching the lower limit of said window. After said slope becomes known, a target point is calculated along a projection of this curve, preferably halfway through said window. The target point can be defined either in terms of an angle or in terms of a torque value.

The document shows an example of the results of the method, in which 54 threaded joints were tightened to a preload below the 50.62 kN elastic limit of the ⅜″×2.4″ bolts, said preload being 30 kN minimum and 45 kN maximum.

The histogram of the results of the method, plotted from the preload values given in Table 1 in columns 24 and 25 of the document, is shown below.

Average preload is 39,151 kN and standard deviation is 5,518 kN, which equals approximately 14% of said average.

From these results, it is evident that the method described in this patent document cannot be considered a “high-precision” process.

### BRIEF DESCRIPTION OF THE INVENTION

It is, therefore, the object of the present invention to present a method to be applied as an integral part of a computer program that operates manual or automatically the conventional spindle machines. This method uses the results of the researches already existing in conventional tightening equipments, extracting from them fundamental information for the final high precision tightening of each individual threaded element, improving considerably the quality of the automated assembly processes in several industrial fields.

The process of the present invention is based on the use of the “torsion angle” produced by tightening momentum (tightening torque) necessary to obtain the clamp load of the joint's plates. Said “torsion angle” is generated due to the reaction that the threaded fastener exercises for a clamping force to be reached.

As is known, this reaction is overcome through a torque that is applied by the wrench comprised in the tightening equipment, either driven by hand or by an electric or pneumatic motor.

This torsion angle resulting in the axle that connects the equipment to the socket (wrench that is connected to the fastener) is a function of the geometrical characteristics of the elements comprised in the assembly and also by shearing modulus of these elements, including the axle.

Therefore, the method presented here is based on the analysis of torque×angle curves that will be plotted in real time during the tightening process of each individual threaded element.

While not being reported by the technical literature, included in this angle of displacement there is a torsion angle that is the result of the torsion to which the components are submitted due to the momentum needed for attaining a clamp load as can be seen on equation number (2), below:

$${M}_{A} = {F}_{M} \cdot ( 0 , 16 \cdot p + {d}_{2} \cdot {μ}_{G} \cdot 0 , 58 + \frac{{d}_{KM}}{2} \cdot {μ}_{K} ) \qquad ( 2 )$$

In addition, is worth remembering that at the moment the torque stops, the angle of torsion expressed through equation (2) and applied on the plates, axle, and sockets is relieved.

Therefore, by equations (1) and (2) it is observed that the attainment of the clamp load, that is the fundamental aim of any tightening process, results from an applied wrench torque, whose presence is unavoidable.

As it is seen by analysis of the equations (1) and (2), to reach the clamp load during the tightening of a threaded element an angle α and a torque M_{A} are generated. This angle α has to be added to an angle of torsion θ resulting from the fastener torsion and torsion plate, axle, socket; in possession of these parameters and according to the present method, during the act of pretightening, untightening and retightening that the conventional equipment executes, is possible to get precise parameters that allow to reach a predetermined clamp load for the final tightening in the elastic or plastic zone, by control of the torque or of the displacement angle.

### BRIEF DESCRIPTION OF THE DRAWINGS

The advantages and features of the present invention will be better understood through the description of an exemplary non-limiting embodiment of the invention and the attached drawings in which:

FIG. 1 depicts a plot 1 where besides the momentum M_{A} we can see the angle α in which the torsion angle θ described on equation number 3 is included.

FIG. 2 is a graphic representation of the sequence of the processes of pretightening, untightening and retightening, where it is seen the untightenig torque in the opposite direction of the tightening torque, allowing to observe that in this interval there is an angular variation without the clamp load being changed, observing also that the only angle that has changed is the torsion angle which can be measured in the referred graphic 2;

FIG. 3 depicts graph 3 where it can be seen the proportionality between the part of θₜ and θ_{t′} which are, effectively, the torsion angle of the threaded fastener; and

FIG. 4 shows graph 4 which is an alterantive representation of graph 3 showing the stopping point for obtaining a previously chosen clamping force, either by torque M_{AF}, or by the displacement angle α_{F}.

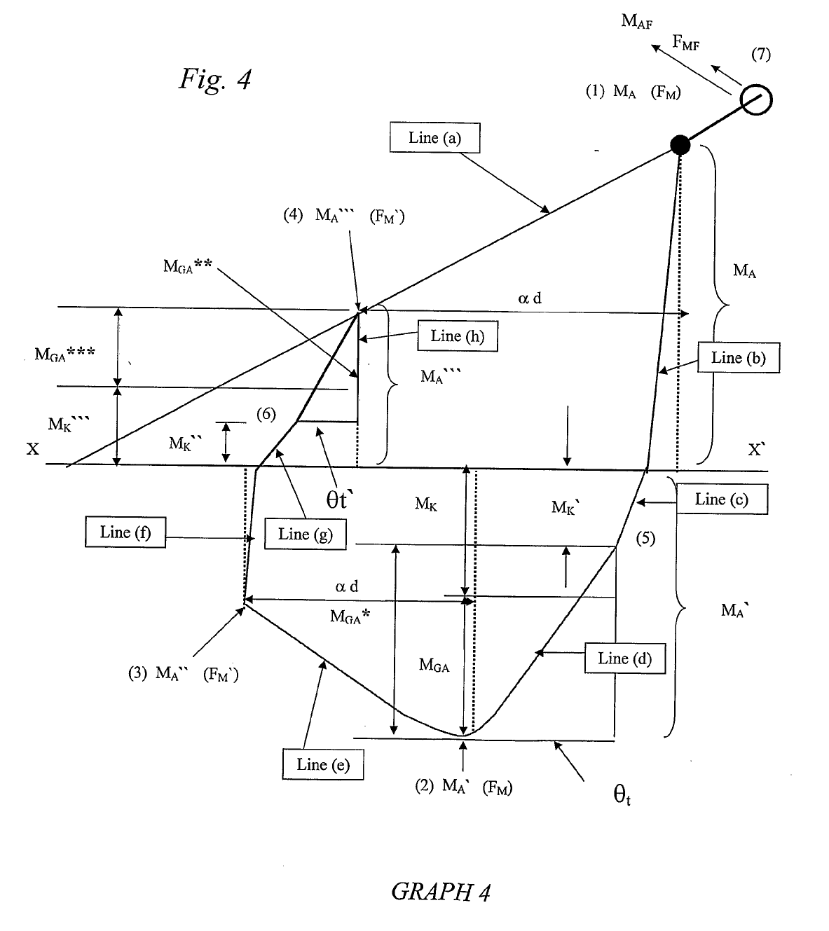

### DETAILED DESCRIPTION OF THE INVENTION

According to the illustrations and to the equations presented hereinafter, the present invention concerns a new method specially developed to be applied as an integral part of a software program that runs conventional spindle machines, either manual or automatic, It employs the features already existing on conventional tightening equipment extracting from them, in real time, the fundamental parameters for the final tightening of each threaded element, (bolt, nut and related elements)

According to the present invention the method in question utilizes the variable “torsion angle” 0 obtained on the operation of pretightening—untightening—retightening performed by the spindle, the above mentioned “TORSION ANGLE” θ being extracted from parameters of torque and displacement angle necessary for reaching the clamp load to joint the parts (fastener and plates) that are acting over each mentioned threaded fastener, in the moment of its clamping; said torsion angle θ takes into consideration many geometrical characteristics of these mentioned threaded elements used in assembly line and also the shearing modulus of those elements.

The method that will be described uses a series of equations and proceedings that will be, when applied, converted into digital data for readings and operation of a software allowing the acquisition and monitoring of the parameter “torque angle θ” of all threaded elements, individually and sequentially, without any interruption or failure of readings in association to the torque angle of displacement.

Considering again the equation (1) it can be seen that the torsion angle θ is not plainly expressed, however as the spindle equipment measures simultaneously the torsion angle concomitantly and the angle of displacement, equation (1) can be written correctly by adding the torsion angle θ, with the following observation: the angle α measured in the instrument comprises the angle α as expressed in equation (1) plus an angle of torsion θ which results from by the momentum needed to attain the angular displacement α. Therefore, equation (1) can be rewritten as follows:

$$\begin{matrix}α = {F}_{M} \cdot \frac{360}{p} ( {δ}_{s} + {δ}_{p} ) + θ & ( 3 ) \\ α = {F}_{M} \cdot \frac{360}{p} \cdot ( {δ}_{s} + {δ}_{p} ) + ( {θ}_{1} + {θ}_{2} ) & ( 3. a )\end{matrix}$$

Where:

θ₁=Threaded fastener torsion angle

θ₂=Torsion plate angle, axle, etc

The torsion angle θ₁ in equation (1) is the torsion angle generated by the torsion of the threaded fastener by a torsion momentum of following magnitude:

M_{GA}=F_{M}·(0,16·p+d₂·μ_{G}·0,58) (4)

The torsion angle θ is the sum of the torsion undergone by the threaded fasteners to which momentum M_{GA} (equation 4) is applied, plus the torsion angle resulting from the application of the torque expressed by equation (2) upon the joined plates as well as the axle and wrench that transmit the momentum defined by the above equation.

Therefore, the torsion angle θ represents the torsion angle of the threaded fastener when its body undergoes the torsion of the equation (4) plus the torsion angle of the joined plates and axle, to which the torque expressed by equation (2) is applied.

Consequently, the present invention's inventive concept consists in measuring the magnitude of the individual torque expressed by equation (2), using the torsion angle and also, using said torsion angle, to measure the clamp load and the thread friction coefficient. The values found in these measurements will be the parameters that determine the torque and the angle of displacement needed for the final tightening stage that results in the previously specified clamp force, either in the elastic or in the plastic zone.

Therefore equation (2) it can be rewritten in the following way:

$${M}_{A} = {F}_{M} \cdot 0 , 16 \cdot p + {F}_{M} \cdot {d}_{2} \cdot {μ}_{G} \cdot 0 , 58 + {F}_{M} \cdot \frac{{d}_{KM}}{2} \cdot {μ}_{K} \qquad ( 5 )$$

Where the various components on the right side are defined as follows:

$$\begin{matrix}{F}_{M} \cdot 0 , 16 \cdot p = {M}_{1} & ( 6 ) \\ {F}_{M} \cdot {d}_{2} \cdot {μ}_{G} \cdot 0 , 58 = {M}_{2} & ( 7 ) \\ {F}_{M} \cdot \frac{{d}_{KM}}{2} \cdot {μ}_{K} = {M}_{3} & ( 8 )\end{matrix}$$

So that equation (5) can be rewritten as:

M_{A}=M₁+M₂+M₃ (9)

In the expressions (5), (6), (7) and (8):

μ_{G}=Friction coefficient in internal and external thread interaction

μ_{K}=Friction coefficient on contact surfaces of head/nut against the joined plates

$$\frac{{d}_{KM}}{2} = Friction radius$$

$${M}_{A} = Tightening torque$$

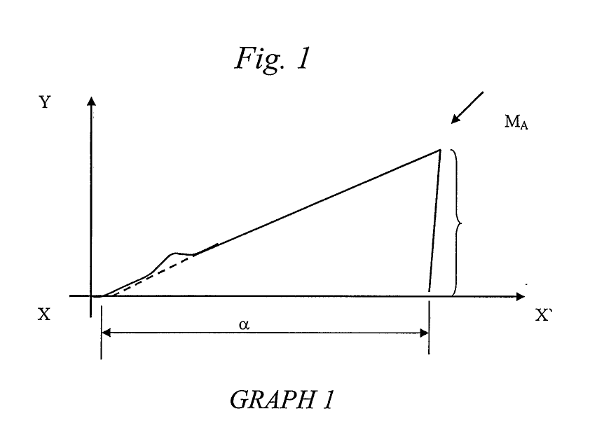

When reaching the stop point during the tightening operation, as illustrated on graphic number 1 (FIG. 1), a precisely determined torque value will be reached. This torque is equal at M_{A}, however we do not know which are the partial torques M₁,M₂,M₃, which cannot be individually determined by the conventional processes.

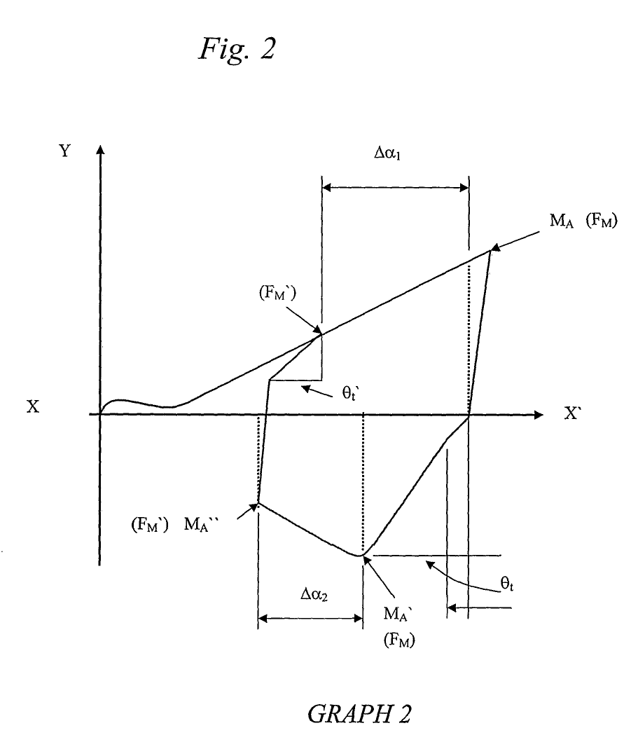

To allow the separation of these partial torque components M₁, M₂, M₃, as well as other ones, the present method uses the torsion angle, following the procedure depicted on FIG. 2. As shown, after reaching the maximum tightening point of the threaded element a controlled untightening step is performed, in which the clamping force is not fully relieved, following a retightening step in which new torque limits can be arrived at.

The torque value to be reached before untightening is given by equation number (10):

$${M}_{A}^{′} = {F}_{M} \cdot ( - 0 , 16 \cdot p + {d}_{2} \cdot {μ}_{G} \cdot 0 , 58 + \frac{{d}_{KM}}{2} \cdot {μ}_{K} ) \qquad ( 10 )$$

Upon reaching the point where the clamp load starts to diminish, torque M_{A}′ also begins to decrease until the point where a new stop point is reached, in which F_{M} is smaller than the previous maximum value although bigger than 0 (zero). At this point the torque will be:

$${M}_{A}^{″} = {F}_{M}^{′} ( - 0 , 16 \cdot p + {d}_{2} \cdot {μ}_{G} \cdot 0 , 58 + \frac{{d}_{KM}}{2} \cdot {μ}_{K} ) \qquad ( 11 )$$

At this point M_{A}″, the equipment tightens again the threaded element clamp until the point where force F_{M}′ starts to increase, which corresponds to another control point.

The torque to be found at this point will be:

$${M}_{A}^{′′′} = {F}_{M}^{′} ( 0 , 16 \cdot p + {d}_{2} \cdot {μ}_{G} \cdot 0 , 58 + \frac{{d}_{KM}}{2} \cdot {μ}_{K} ) \qquad ( 12 )$$

Therefore, graph number (1) shows, besides momentum M_{A} the angle α defined on equation number (3).

On graph 2 (FIG. 2) it can be seen that when the process is interrupted (rest condition) the torsion angle to which the set, plates and axle were submitted disappears.

When an untightening torque begins in the opposite direction, the torsion angle of the threaded fastener is distended and a new torsion angle is generated on the components. Returning to equation (1) it is seen that the angle of displacement α is produced as a function of the variation of the clamping force.

In this interval there is an angular variation but the clamping force did not change; the only angle that has changed by distention or by torsion was the torsion angle, which can be measured on graphic (2).

The torsion angle is due to the torque applied to the fastener that promoted the growth of F_{M} from zero reaching the maximum and starting to decrease. The torque values included in this interval consist of the sum of the torques defined by equations (2) and (10).

From the sum of said two equations results the torque that has produced the torsion in the bolt plus the torsion on the plates and axle, the torsion on the plates and axle resulting only from equation (10).

$${M}_{A} = {F}_{M} \cdot 0 , 16 , \cdot p + {F}_{M} \cdot 0 , 58 \cdot {d}_{2} \cdot {μ}_{G} + {F}_{M} \cdot \frac{{d}_{KM}}{2} \cdot {μ}_{K} \\ \frac{{M}_{A}^{′} = \begin{matrix}- {F}_{M} \cdot 0 , 16 \cdot p + \\ {F}_{M} \cdot 0 , 58 \cdot {d}_{2} \cdot {μ}_{G} + {F}_{M} \cdot \frac{{d}_{KM}}{2} \cdot {μ}_{K}\end{matrix}}{{M}_{A}^{*} = 0 + 2 \cdot {F}_{M} \cdot 0 , 58 \cdot {d}_{2} \cdot {μ}_{G} + 2 \cdot {F}_{M} \cdot \frac{{d}_{KM}}{2} \cdot {μ}_{K}} \qquad ( 13 )$$

So, the torque that originates the torsion angle measured on the X-X′ axis in said graph and M_{A}* is:

$${M}_{A}^{*} = 2 \cdot {F}_{M} \cdot {d}_{2} \cdot {μ}_{G} \cdot 0 , 58 + 2 \cdot {F}_{M} \cdot \frac{{d}_{KM}}{2} \cdot {μ}_{K} \qquad ( 14 )$$

When M_{A}* is reached, the torsion angle generated during the tightening process is distended and the angle—generated by the untightening torque until the clamping force begins to decrease—reaches its maximum. There will be at this moment a torsion angle θₜ that decreases according to the reduction of the clamping force, reaching zero when the clamping force has vanished completely.

However, as the clamping force reduction is interrupted before it reaches zero, at the point M_{A}″ there will remain a torsion angle as a function of the torque at this point with the following magnitude:

$${M}_{A}^{``} = {F}_{M}^{‵} ( - 0 , 16 \cdot p + {d}_{2} \cdot {μ}_{G} \cdot 0 , 58 + \frac{{d}_{KM}}{2} \cdot {μ}_{K} )$$

It should be noticed that between the points M_{A}′ and M_{A}″ there was a reduction of the clamping force, so that an angle of displacement α was produced.

At the point M_{A}″, the retightening of the bolt starts again, and the wrench rotation is reversed. During said retightening the plot goes through the M_{A}′″ torque value, where the clamping force resumes its increase.

Between points M_{A}″ and M_{A}′″, the clamping force remained unchanged and therefore, no angle of displacement a was produced. The only angles shown in the graph are the torsion angles.

The torsion angle θₜ′ is a consequence of the addition of the torques M_{A}″ and M_{A}′″, therefore:

$$\frac{\begin{matrix}{M}_{A}^{``} = {F}_{M}^{‵} ( - 0 , 16 \cdot p + {d}_{2} \cdot {μ}_{G} \cdot 0 , 58 + \frac{{d}_{KM}}{2} \cdot {μ}_{K} ) \\ + \\ {M}_{A}^{‵‵‵} = {F}_{M}^{‵} ( - 0 , 16 \cdot p + {d}_{2} \cdot {μ}_{G} \cdot 0 , 58 + \frac{{d}_{KM}}{2} \cdot {μ}_{K} )\end{matrix}}{{M}_{A}^{``} + {M}_{A}^{‵‵‵} = 2 \cdot {F}_{M}^{‵} ( {d}_{2} \cdot {μ}_{G} \cdot 0 , 58 + \frac{{d}_{KM}}{2} \cdot {μ}_{K} )}$$

Disregarding the components of the torsion angle θ originating from the plates and axle, which are different by action of M_{A′} and M_{A″} (these differences are insignificant) it can be said that the angles θₜ and θₜ′ are proportional and that their slopes are equal, being the angular coefficient of the straight line

$$\frac{{M}_{A}^{‵‵‵}}{{θ}_{t}^{‵}} = \frac{{M}_{A}^{‵}}{{θ}_{t}} \qquad ( 15 )$$

So, if we call

$${λ}_{1} = \frac{{M}_{A}^{‵}}{{θ}_{t}} = \frac{{M}_{A}^{``}}{{θ}_{t}^{‵}} \qquad ( 16 )$$

Or doing:

$${λ}_{2} = \frac{{θ}_{t}}{{θ}_{t}^{‵}} \qquad ( 17 )$$

We can state that:

$$\frac{{F}_{M}}{{F}_{M}^{‵}} = {λ}_{2} \qquad ( 18 )$$

An important aspect concerning the analysis of graph (2), is that the linearity between the points in axis X, X′ and of M_{A}′ between the torque and the angle only occurs in the amplitude relationship of the torque that has generated the torsion angle. What can be said is that the angle θₜ is function from the torque that has produced it and its magnitude is also related to the dimensional properties and resistance of the elements involved, the largest part of this angle being a consequence of the torque undergone by the body of the threaded element, said torque being the torque necessary to overcome the friction on the thread and the required torque to generate the clamping force when the bolt is being tightened and the torque necessary to start the decrease of the clamping load.

On the graph we cannot separate the θₜ corresponding to the bolt's body from the other components due to the action of the overall torque, which includes the torques to overcome the friction on head/nut. Returning to equation (13) and analyzing it in greater depth, it can be seen that the component θₜ of the torsion angle generated by the bolt will be a function of its geometrical features of resistance and torques that effectively generate torsion on the threaded fastener's body as follows:

$$\frac{\begin{matrix}{M}_{GA} = {F}_{M} ( 0 , 16 \cdot p + {d}_{2} \cdot {μ}_{G} \cdot 0 , 58 ) \\ + \\ {M}_{GA}^{‵} = {F}_{M} ( - 0 , 16 \cdot p + {d}_{2} \cdot {μ}_{G} \cdot 0 , 58 )\end{matrix}}{{M}_{GA}^{*} = 2 \cdot {F}_{M} \cdot {d}_{2} \cdot {μ}_{G} \cdot 0 , 58} \qquad ( 19 )$$

Therefore, the component of angle θₜ due to the fastener clamping will be the resultant from the torque of the equation (19).

The equation (20) follows the same reasoning line, and we will have:

M_{GA}**=2·F_{M}′·d₂·μ_{G}·0,58 (20)

Once more there is a proportionality between the components of θₜ and θₜ′ that are effectively the torsion angle of the threaded fastener. This proportionality will be used on the analysis on which the present patent application is based.

A better example of the above can be seen on graph (3), where:

$${M}_{A}^{‵} = {F}_{M} \cdot ( - 0 , 16 \cdot p + {d}_{2} \cdot {μ}_{G} \cdot 0 , 58 + \frac{{d}_{KM}}{2} \cdot {μ}_{K} )$$

$${M}_{K} = {F}_{M} \cdot \frac{{d}_{KM}}{2} \cdot {μ}_{K}$$

$${M}_{GA}^{*} = {F}_{M} \cdot 2 \cdot {d}_{2} \cdot {μ}_{G} \cdot 0 , 58$$

However:
M_{A}′ as already seen, is defined by equation (10);
M_{GA}* is the torque that maintains the proportionality between the angle of torsion and the torque in the graph. So we can write:

M_{K}′=M_{A}′−M_{GA}*

M_{K}′=−F_{M}·0,16·p+F_{M}·d₂·μ_{G}·0,58+M_{K}−F_{M}·2·d₂·μ_{G}·0,58

M_{K}′=−F_{M}·0,16·p+F_{M}·d₂·μ_{G}·0,58+M_{K}−2 F_{M}·d₂·μ_{G}·0.58

M_{K}′=−F_{M}·0,16·p−F_{M}·d₂·μ_{G}·0,58+M_{K}

M_{K}′=M_{K}−F_{M}(0,16·p+d₂·μ_{G}·0,58) (22)

Repeating the same reasoning between the points defined by the X-X′ axis until the point M_{A}′″, we can find the expression that defined Mₖ″, that is the torque where the proportionality between the torsion angle and the torque does not exist.

$${M}_{K}^{``} = {M}_{A}^{‵‵‵} - {M}_{GA}^{**} \\ {M}_{K}^{``} = {M}_{A}^{‵‵‵} - {M}_{GA}^{**} \\ {M}_{K}^{``} = {F}_{M}^{‵} ( 0 , 16 \cdot p + {d}_{2} \cdot {μ}_{G} \cdot 0 , 58 + \frac{{d}_{KM}}{2} \cdot {μ}_{{K}^{′}} ) - {F}_{M}^{‵} \cdot 2 \cdot {d}_{2} \cdot {μ}_{G} \cdot 0 , 58 \\ {M}_{K}^{``} = {F}_{M}^{‵} ( 0 , 16 \cdot p + {F}_{{M}^{′}} \cdot {d}_{2} \cdot {μ}_{G} \cdot 0 , 58 ) + {M}_{K}^{‵} - {F}_{M}^{‵} \cdot 2 \cdot {d}_{2} \cdot {μ}_{G} \cdot 0 , 58 \qquad ( 23 )$$

By analysis of graph 3, it is therefore possible to find the individual components of torque M_{A}, seen on graphs (1), (2) and (3), using the principles that will be explained in the following lines. First, it must be remembered that torque M_{A} is constituted of the torques anticipated in equations (6), (7) and (8) where:

$${M}_{A} = {M}_{1} + {M}_{2} + {M}_{3}$$

$${M}_{1} = {F}_{M} \cdot 0 , 16 \cdot p$$

$${M}_{2} = {F}_{M} \cdot {d}_{2} \cdot {μ}_{G} \cdot 0 , 58$$

$${M}_{3} = {F}_{M} \cdot \frac{{d}_{KM}}{2} \cdot {μ}_{K}$$

From the portion of the graph that shows a proportionality in the region between the X-X′ axis and the torque M_{A}′ it is possible to extract the torque of proportionality that is:

M_{GA}*=F_{M}·2·d₂·μ_{G}·0,58

Dividing by 2, results:

M₂=F_{M}·d₂·μ_{G}·0,58 (24)

Analyzing the graphic (3), it can be observed that there is no way of determining the value of M₃. However, associating the leg of the graph between X-X′ and M_{A}′ and between X-X′ and M_{A}′″, one will find M₃, which is Mₖ, using equations (22) and (23), but before it becomes necessary to correct the value of F_{M}′ used on equation (23), knowing that:

$$\begin{matrix}\frac{{F}_{M}}{{F}_{M}^{‵}} = {λ}_{2} \\ and & ( 25 ) \\ {λ}_{2} = \frac{{θ}_{t}}{{θ}_{{t}_{1}}} & ( 26 )\end{matrix}$$

One may compare, then, Mₖ′ and Mₖ″ in the same basis and then say that Mₖ can be found from equations (22) and (23) making F_{M}′=F_{M} by multiplication by λ₂ which will be taken from the graph.

$${M}_{K} = ( \frac{{M}_{K}^{‵} + ( {λ}_{2} \cdot {M}_{K}^{``} )}{2} ) = {F}_{M} \cdot {d}_{2} \cdot {μ}_{G} \cdot 0 , 58 \qquad ( 27 )$$

Considering that one can take M_{K}′ and M_{K}′ from the graph it becomes possible to obtain the value of M_{K}=M₃; returning to M_{A}, one can write:

$$\begin{matrix}{M}_{A} - {M}_{2} - {M}_{3} = {M}_{1} \\ {M}_{1} = {F}_{M} \cdot 0 , 16 \cdot p & ( 28 ) \\ \frac{{M}_{1}}{0 , 16 \cdot p} = {F}_{M} & ( 29 )\end{matrix}$$

The thread's friction coefficient (μ_{G}) and the clamping force will also be calculated by analyzing the angles of torsion θₜ and Θₜ′.

The torsion tension is a function of the torsion momentum undergone by the body of threaded element and can be measured through the torsion angle θ obtained from the graph showing the tightening by torque control×angle, when the values of torque and untightening angle are plotted.

The measured torsion angle measured, although being contaminated by the torsion joint's torsion which for practical purposes can often be disregarded—or, when higher precision is needed can be studied separately—is a consequence of the momentum as expressed on equation (20):

M_{GA}*=2·F_{M}·d₂·μ_{G}·0,58

Equation (30) shows the relationship between the torsion stress and the axial stress:

$$\frac{τ}{{σ}_{M}} = \frac{2 \cdot {d}_{2}}{{d}_{3}} ( \frac{p}{π \cdot {d}_{2}} + 1 , 155 \cdot {μ}_{G} ) \qquad ( 30 )$$

Where:

τ=Shear stress

σ_{M}=Axial stress

d₂=Pitch thread diameter

d₃=Internal thread diameter

Analyzing attentively the equation (30) it can be observed that the relation τ/σ_{M} is considered by a torque applied to the fastener's body that grows as the clamping force grows, i.e. an input torque where the expression F_{M}·0,16. p is positive.

However, in the untightening graph the torsion angle θ, from which the stress τ is derived, is an angle resulting from the addition of the input torque plus the output torque, therefore the resulting magnitude of τ found will be the sum of τₑ+τₛ (torsion stress τₑ referring to the input torque+τₛ referring to the output torque).

τ=τₑ+τₛ (31)

One can, therefore, write the interrelations between τₑ and τₛ and σ_{M}:

τₑ=Shear stress due to the tightening torque

τₛ=Shear stress due to the untightening torque.

$$\begin{matrix}\frac{{τ}_{e}}{{σ}_{M}} = \frac{2 \cdot {d}_{2}}{{d}_{3}} ( \frac{p}{π {d}_{2}} + 1 , 155 {μ}_{G} ) \\ + \\ \frac{{τ}_{s}}{{σ}_{M}} = \frac{2 \cdot {d}_{2}}{{d}_{3}} ( - \frac{p}{π \cdot {d}_{2}} + 1 , 155 {μ}_{G} ) \\ \frac{{τ}_{e} + {τ}_{s}}{{σ}_{M}} = \frac{4 \cdot {d}_{2}}{{d}_{3}} \cdot 1 , 155 {μ}_{G}\end{matrix} \qquad ( 32 )$$

As σ_{M}·A_{S}=F_{M}, one has that:

Aₛ=Resisting area

$${σ}_{M} = \frac{{F}_{M}}{{A}_{s}} = \frac{4 \cdot {F}_{M}}{{π ( \frac{{d}_{2} + {d}_{3}}{2} )}^{2}} \qquad ( 33 )$$

Substituting σ_{M} from equation (33) in equation (32) it results:

$${τ}_{e} + {τ}_{s} = \frac{4 \cdot {d}_{2} \cdot 1 , 155 \cdot {μ}_{G}}{{d}_{3}} \cdot \frac{4 \cdot {F}_{M}}{{π ( \frac{{d}_{2} + {d}_{3}}{2} )}^{2}} \qquad ( 34 )$$

However F_{M} can be expressed as

$${F}_{M} = \frac{α d \cdot p}{360 \cdot ( {δ}_{s} + {δ}_{p} )} \qquad ( 35 )$$

And (δₛ+δₚ) can be substituted by:

$$( {δ}_{s} + {δ}_{p} ) = \frac{α d \cdot p \cdot d [ \frac{2.0 , 16 \cdot p}{d [ \frac{{M}_{A}}{{M}_{A}^{‵}} - 1 ]} ]}{{M}_{A}^{‵} \cdot 360} \qquad ( 36 )$$

So, in equation (37) (δₛ+δₚ) will be substituted by equation (38).

Therefore, F_{M} may be rewritten as:

$${F}_{M} = \frac{{M}_{A}^{‵}}{[ \frac{2 , 0 , 16 , p}{d ( \frac{{M}_{A}}{{M}_{A}^{‵}} - 1 ) \cdot α \cdot p} ]}$$

Which, after performing the above amplifications, results in:

$${F}_{M} = \frac{{M}_{A}^{‵}}{[ \frac{2 \cdot 0 , 16 , p}{d ( \frac{{M}_{A}}{{M}_{A}^{‵}} - 1 )} ] \cdot d} \qquad ( 37 )$$

Substituting now F_{M} on equation (34) by F_{M} from equation (37) results:

$$\begin{matrix}{τ}_{e} + {τ}_{s} = \frac{4 \cdot {d}_{2} 1 , 155 \cdot {μ}_{G}}{{d}_{3}} \cdot \frac{4}{{π ( \frac{{d}_{2} + {d}_{3}}{2} )}^{2}} \cdot \frac{{M}_{A}^{‵}}{[ \frac{2 \cdot 0 , 16 , p}{d \cdot [ \frac{{M}_{A}}{{M}_{A}^{‵}} - 1 ]} ] \cdot d} & ( 38 ) \\ However , ( {τ}_{e} + {τ}_{s} ) = {τ}_{T} , where \text{:} & ( 39 ) \\ {τ}_{T} = \frac{{M}_{GA}^{*} \cdot r}{J} = \frac{{M}_{GA}^{*} \cdot {d}_{s}}{2 \cdot {J}_{p}} & ( 40 )\end{matrix}$$

In which Jₚ=Polar inertial momentum

$${d}_{s} = \frac{{d}_{2} + {d}_{3}}{2} \qquad ( 41 )$$

In this way, one can rewrite equation (38) from equations (40) and (41):

$$\frac{{M}_{GA}^{*} \cdot ( {d}_{2} + {d}_{3} )}{4 \cdot J} = \frac{4 \cdot {d}_{2} \cdot 1 , 155 \cdot 4 \cdot {M}_{A}^{‵}}{{d}_{3} \cdot π \cdot {( \frac{{d}_{2} + {d}_{3}}{2} )}^{2} \cdot [ \frac{2 \cdot 0 , 16 \cdot p}{d \cdot [ \frac{{M}_{A}}{{M}_{A}^{‵}} - 1 ]} ] \cdot d} \cdot {μ}_{G} \\ {μ}_{G} = \frac{\begin{matrix}{M}_{GA}^{*} \cdot ( {d}_{2} + {d}_{3} ) \cdot {d}_{2} \cdot π \cdot \\ {( \frac{{d}_{2} + {d}_{3}}{2} )}^{2} \cdot [ \frac{2 \cdot 0 , 16 \cdot p}{d \cdot [ \frac{{M}_{A}}{{M}_{A}^{‵}} - 1 ]} ] \cdot d\end{matrix}}{4 \cdot {J}_{p} \cdot 4 \cdot {d}_{2} \cdot 1 , 155 \cdot 4 \cdot {M}_{A}^{‵}} \\ {μ}_{g} = \frac{\begin{matrix}{M}_{GA}^{*} \cdot ( {d}_{2} + {d}_{3} ) \cdot {d}_{2} \cdot π \cdot \\ {( \frac{{d}_{2} + {d}_{3}}{2} )}^{2} \cdot [ \frac{2 \cdot 0 , 16 \cdot p}{d \cdot [ \frac{{M}_{A}}{{M}_{A}^{‵}} - 1 ]} ] \cdot d\end{matrix}}{73 , 92 \cdot {J}_{p} \cdot {d}_{2} \cdot {M}_{A}^{‵}} \qquad ( 42 )$$

Where, after simplifying one has:

$${μ}_{G} = \frac{0 , 855 \cdot {M}_{GA}^{*} \cdot {d}_{3} \cdot [ \frac{0 , 32 \cdot p}{d \cdot [ \frac{{M}_{A}}{{M}_{A}^{‵}} - 1 ]} ] \cdot d}{{d}_{s} \cdot {d}_{2} \cdot {M}_{A}^{‵}} \qquad ( 43 )$$

Or as a function of M_{A}′″, M_{A}″ and M_{GA}**

All parameters shown on graph (3) determined with the aid of the friction coefficient μ_{G}, also determined as a function of said parameters. It will be therefore possible to determine the clamping force at the points M_{A}, M_{A}′″ and thus the friction coefficient μₖ can be calculated as well as the torque's coefficient designated as K. Having these values, one can return to the equation (2) and calculate then the torque needed to reach the final previously chosen clamping force.

Graph (4) shows the process of the invention, consisting of pretighten, untighten, retighten and final tightening operations.

The operations that are shown on graph (3) are therefore performed to find the features of the interactions between the threaded fasteners and jointed plates. Every parameter described there will be calculated in real time and that information will be used, in real time also, to get a torque or angle that reaches the previously chosen clamping force.

After determining μ_{G} through equation (42) or (43) and F_{M} by equation (6) or by equation (37) as well as μk by equation (8), nd substituting these values on equation (2) in which F_{MF} has been previously chosen, the torque M_{AF} necessary to attain F_{MF} will be obtained.

Another method for calculating the final torque M_{AF}, needed to reach F_{MF}, will be by calculating the K torque coefficient through parameters found in the plot of graph (3) with the aid of equation (6) or equation (37) and M_{A}:

$$K = \frac{{M}_{A}}{{F}_{M} \cdot d} \qquad ( 44 )$$

As K is constant in the whole straight line, the K found on graph (3) can be used for the graph (4), therefore the M_{AF} needed to reach F_{MF} will have the following value:

M_{AF}=F_{MF}·d·K (45)

In this way every equation and graphic information will be converted to digital data in order to be used by the program that controls and operates the spindle machines, seeking mainly to monitor in real time each individual threaded fastener through the operations of tightening, untightening and retightening in order to obtain the parameter “torsion angle” associated to the torque and angle of displacement.

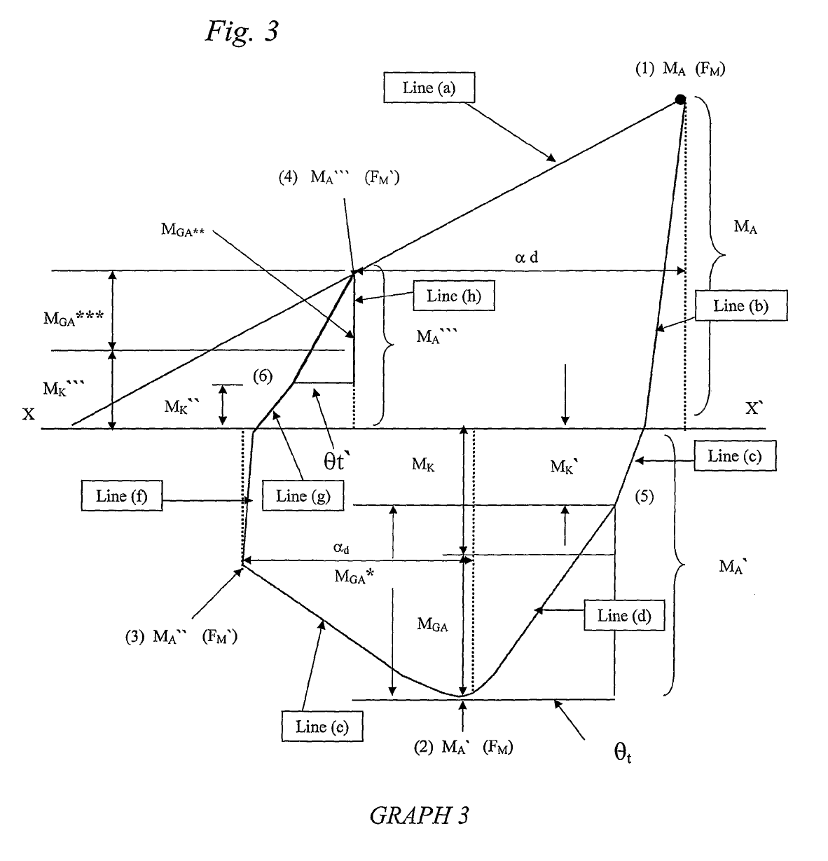

After all these commentaries the method in question can be described employing the following process of tightening based on FIG. 3:

a) Initiate the tightening process using an automatic or manual spindle machine comprising means for real time simultaneous monitoring of torque and angle;

b) Tighten the threaded fastener to reach a torque M_{A} from equation (1) in order to generate the line (a); the torque M_{A} will be larger than zero and smaller than the estimated final torque that will result in the previously established clamping force;

c) Untighten the threaded fastener until a M_{A}″ torque is reached; the M_{A}″ torque will be [M_{A}″]<[M_{A}′]<[M_{A}], its magnitude being freely chosen by the operators as long as M_{A}″ is bigger than zero; during this step, the lines (b), (c), (d) and (f) will be generated;

d) Retighten the threaded fastener up to M_{A} or any other torque that reaches the line (a) smaller than M_{A}; during this process the lines (g) and (h) will be generated; the torque M_{A}′″ will be given by the intersection of line (a) and line (h).

The above described sequence provides the information that will be used to calculate a specific torque M_{AF} for each threaded fastener, said torque being applied in a final step to tighten the threaded fastener in order to reach the clamping force with high precision on elastic zone or, alternatively, an angle α_{F} to reach the clamping force in the elastic or plastic zone with high precision.

According to the information the following data will be acquired through the process of the invention:

a) Torque M_{A}

b) Torque Mₖ′

c) Torque M_{A}′

d) Torque M_{A}″

e) Torque Mₖ″

f) Torque M_{GA}*

g) Torque M_{GA}**

h) Angle θₜ

i) Angle θₜ′

j) Friction coefficient μ_{G}

In possession of the values obtained from the relationship torque×angle during the process under consideration and with the aid of the mathematical treatment of data described in the present patent application it becomes possible to calculate either the torque M_{AF} necessary for tightening the threaded fastener in the elastic zone or an angle α_{F} for tightening in the elastic or plastic zones with the previously chosen clamping force, with small dispersion, by means of the following procedures given as non-limiting examples:

1^{st} Procedure:

Calculating the torque M_{AF}, to reach the previously established clamping force through the determination of the thread friction coefficient μ_{G} according to equations (42) or (43);

The value of μ_{G} can be found using equation number (43), by inserting in said equation the values of M_{A}, M_{A}′, M_{GA}*, obtained in the curves or also by insertion of M_{A}′″ substituting M_{A}, M_{A}″ substituting M_{A}′ and M_{GA}** in the place of M_{GA}*;

After calculating the value of μ_{G} obtained by using equation (42) or (43), it will be possible to determine the clamping force in the point M_{A} or M_{A}′″ as functions of the values taken from the graph through the use of equation (19) or equation (20).

M_{GA}*=2·F_{M}·d₂·μ_{G}·0,58

M_{GA}**=2·F_{M}′·d₂·μ_{G}·0,58

M_{GA}* and M_{GA}** are taken from the graph 3, d₂ being the thread pitch diameter used, enabling one to find the value of either F_{M} or F_{M}′ whether either M_{A}, M_{A}′ and M_{GA}* are used or M_{A}′″, M_{A}″, M_{GA}** are used;

With the values of F_{M} or F_{M}′, given by equation (44) it will be possible find the value of the torque coefficient K; and

After finding the torque coefficient, the magnitude of torque M_{AF} can be determined through equation (45).

2^{nd} Procedure

From the values of θₜ, θₜ′ taken from the curves, λ₂ is calculated according to equation (26); extracting from the graph 3 the values of Mₖ′ and Mₖ″ and M₂ from equation (24), which is M_{GA}* from equation (19) divided by 2, it will be possible to calculate with the aid of equation (27) the value of Mₖ;

As Mₖ=M₃ [equation (8)] and M₂ is known from the graph, being

$$\frac{{M}_{GA}^{*}}{2} , \qquad [ equation ( 24 ) ]$$

it will be possible by equation (28) to find the value of M₁ by the following expression:

M_{A}−M₂−M₃=M₁

Equation (29) allows one to calculate the clamping force F_{M}; based on the value of F_{M}, the torque coefficient K is found by using equation (44); knowing the torque coefficient K and using the equation (45) it will be possible to calculate the torque M_{AF} necessary to reach the previously established clamping force.

3^{rd} Procedure

Calculating the torque M_{AF} necessary to reach the desired clamping force with the help of K torque's coefficient determined by the following procedure:

From graphic number 3 the values of M_{A}′″, M_{A}″ can be extracted, as they have produced the clamping force F_{M}′; the relationship between the clamping force and the torque is expressed in equation (45) which can be written subtracting from M_{A}′″ the value of M_{A}″ obtaining the following value:

$${M}_{A}^{‵‵‵} = {F}_{M}^{‵} ( 0 , 16 \cdot p + {d}_{2} \cdot {μ}_{G} \cdot 0 , 58 + \frac{{d}_{KM}}{2} \cdot {μ}_{K} )$$

$$and$$

$${M}_{A}^{``} = {F}_{M} ( - 0 , 16 \cdot p + {d}_{2} \cdot {μ}_{G} \cdot 0 , 58 + \frac{{d}_{KM}}{2} \cdot {μ}_{K} )$$

According to the equations (12) and (11) respectively, a torque value will be obtained:

M_{F}=0,32·p·F_{M}′

As

M_{A}′″=K·F_{M}′·d

Therefore, according to the equation (45) one can write:

$${F}_{M}^{‵} = \frac{{M}_{d}^{‵‵‵}}{K \cdot d}$$

$$Then \text{:}$$

$${M}_{A}^{‵‵‵} - {M}_{A}^{``} = 0 , 32 \cdot p \cdot [ \frac{{M}_{A}^{‵‵‵}}{{M}_{A}^{``} \cdot K \cdot d} ]$$

$$K \cdot d = 0 , 32 \cdot p \cdot [ \frac{{M}_{A}^{‵‵‵}}{{M}_{A}^{‵‵‵} - {M}_{A}^{``}} ]$$

$$K = \frac{0 , 32 \cdot p}{d} \cdot [ \frac{{M}_{A}^{‵‵‵}}{{M}_{A}^{‵‵‵} - {M}_{A}^{``}} ]$$

The value of K being known it is possible to calculate the torque M_{AF} seen in the graph (4) necessary to reach the desired F_{MF} through the equation (45).

4^{th} Procedure

Using the parameters obtained in the process defined on graph 3, one can make the final tightening of the threaded fastener, either on the plastic or on the elastic zone by the following procedure:

An angle α_{d} is developed between the torque values M_{A}′″ and M_{A}, between the points (4) and (1) inscribed in the straight line (a); using the procedure described in the present patent application the clamping force F_{M}′ in the point (4) of line (a) and the clamping force F_{M} in the point (1) of line (a) can be determined. Analyzing the graphic 3, it can concluded that the difference of F_{M}−F_{M}′=ΔF_{M}, generated during the tightening process, which produces an angular displacement α_{d}. Then it is possible to calculate an angular coefficient by the following relationship of variation:

$${C}_{α} = \frac{Δ {F}_{M}}{{α}_{d}}$$

As the assembly force (clamping force) can be determined at any stopping point of line (a) depicted on graph 3, it becomes possible, starting from this stop point, to add an angle of displacement α_{F} in the place of an M_{AF} to reach a predeterminated final clamping force that can be in the elastic or in the plastic zone of the threaded fastener by the following procedure:

F_{MP}—clamping force at any point on the line (a) from graphic 3, when the process of tightening, untightening and retightening described in the present patent application and shown in the graph, is stopped along the line (c) at any point between the points (4) and (1).

Subtracting the clamping force F_{MP} from the previously chosen F_{MF}, results:

$$Δ {F}_{M} = {F}_{MF} - {F}_{Mp}$$

$$Dividing$$

$$\frac{Δ {F}_{M}}{{C}_{α}} = {α}_{F}$$

Where α_{F} is the additional angle through which the threaded fastener will be tightened to reach the final desired clamping force, the torque M_{AF} being a consequence of this force and also of the friction coefficient and friction radius. This procedure will allow tightening the threaded fastener on the elastic or on the plastic zone, the latter being reached if the clamping force previously chosen by the user reaches or exceeds the elastic limit of the threaded fastener.

The previous mathematical exposition furnishes the base for the creation of an operational software; the present method is based on the variable “torsion angle” θ as described in the operation sequence of pretightening, untightening and retightening performed by the spindle machine, said “torsion angle” θ being extracted from parameters of torque and angle of displacement needed to obtain the clamping force of the jointed parts (fastener and plates) that will be acting in cooperation during the fastening operation. Said torsion angle θ comprises the influence of several geometric features of said threaded elements as well as their shearing modulus.

The method that has been presented will allow to acquire and to monitor the parameter “torsion angle” θ of all threaded elements, individually and sequentially, without any failure or reading interruption in association with the torque and with the angle of displacement.

Is should be stressed that the present invention is not restricted to the specific applications herein described. The invention can be embodied in a variety of ways, it being understood that the above embodiments have a descriptive purpose and not that of limitation.

1) METHOD FOR ATTAINING A PREDETERMINED CLAMPING FORCE IN THREADED JOINTS through the employment of a plurality of equations and graphs converted into digital data and applied to a system of intelligent monitoring, being part of a computer program or specific software dedicated to operate manual or automatic spindle machines, the needed parameters being measured at the axle of the equipment connected to the wrench that acts over a threaded fastener, such as a bolt, nuts or equivalent element during the fastening operation, characterized in that the acquisition of the data for calculation and utilization the variable “torsion angle” θ, θₜ and θₜ′ occurs during the operation of pretightening untightening and retightening performed by the spindle, said “torsion angle” θ, θₜ and θₜ′ being extracted from parameters of torque and displacement necessary to obtain the clamping force of the jointed parts (plates and fastener) that are acting cooperatively during the tightening operation, said torsion angle θ, θₜ and θₜ′ taking into consideration many geometrical features of the threaded elements as well as their shearing modulus.

2) METHOD, as claimed in claim 1, characterized in that it measures the magnitudes of the individual torque forces expressed by equation (2), through the torsion angle, the latter being used to measure the clamping force and the thread friction coefficient, the resulting magnitudes found in said measurements determining the torque and angle of displacement necessary used in the final tightening operation.

3) METHOD, as claimed in claims 1 or 2, characterized in that the torsion angle θ is the sum of the result of the torsion produced in the elements to which the momentum M_{A} is applied, plus the torsion angle resulting from application of the torque from equation (2)
$${M}_{A} = {F}_{M} \cdot ( 0 , 16 \cdot p + {d}_{2} \cdot {μ}_{G} \cdot 0 , 58 + \frac{{d}_{KM}}{2} \cdot {μ}_{K} )$$
on the joined parts plates and on the wrench axle.

4) METHOD, as claimed in any one of the preceding claims, characterized in that the parameters obtained determine the torque and the angle of displacement necessary for a final operation of tightening within of the elastic zone to attain the previously chosen clamping force.

5) METHOD, as claimed in any one of the preceding claims characterized in that the torsion angle θ added to the equation (1) is the torsion angle generated by the torsion of the threaded fastener by a torsion momentum of magnitude M_{GA}=F_{M}·(0,16·p+d₂·μ_{G}·0,58)—equation (4)—where the torsion angle θ is the result of torsions resulting from the elements to which the momentum M_{A} is applied, plus the torsion angle resulting from the application of the torque of equation (2) on the joined parts plates and in the wrench axle.

6) METHOD, as claimed in claims 1, 3 or 4, characterized in that the magnitudes of individual torque found through equation (2), using the torsion angle and also with the aid of the torsion angle to measure the clamp load and the friction coefficient on the thread; the magnitudes found on these measurements being the parameters that determine the torque and the angle of displacement necessary for a final operation of tightening that reaches the previously chosen claming force within the elastic zone.

7) METHOD, as claimed in any one of the previous claims, characterized in that after reaching the torque limit M_{A} at which the pretightening operation stops—said torque limit comprising a plurality of intermediate partial torque values M₁, M₂, M₃—a controlled untightening operation is performed in which the previously obtained clamping force does not disappear completely, the threaded element being retightened again, reaching new torque limit points according to equation (2) rewritten by equation (5) as
$${M}_{A} = {F}_{M} \cdot 0 , 16 \cdot p + {F}_{M} \cdot {d}_{2} \cdot {μ}_{G} \cdot 0 , 58 + {F}_{M} \cdot \frac{{d}_{KM}}{2} \cdot {μ}_{K}$$
the several right-hand terms being designated as follows:
$$\begin{matrix}{F}_{M} \cdot 0 , 16 \cdot p = {M}_{1} & ( 6 ) \\ {F}_{M} \cdot {d}_{2} \cdot {μ}_{G} \cdot 0 , 58 = {M}_{2} & ( 7 ) \\ {F}_{M} \cdot \frac{{d}_{KM}}{2} \cdot {μ}_{K} = {M}_{3} & ( 8 )\end{matrix}$$
the above torsion limit being then expressed as the sum of the partial torsion values M_{A}=M₁+M₂+M₃ (9).

8) METHOD, as claimed in claim 6, characterized in that the clamping force at which the untightening operation begins is given by the expression
$${M}_{A}^{‵} = {F}_{M} \cdot ( - 0 , 16 \cdot p + {d}_{2} \cdot {μ}_{G} \cdot 0 , 58 + \frac{{d}_{KM}}{2} \cdot {μ}_{K} ) \qquad ( 10 )$$
said untightening operation diminishing the clamping force until a new stopping point is reached in which F_{M} is smaller than the maximum reached but larger than zero, the torque at this point being
$${M}_{A}^{``} = {F}_{M}^{‵} ( - 0 , 16 \cdot p + {d}_{2} \cdot {μ}_{G} \cdot 0 , 58 + \frac{{d}_{KM}}{2} \cdot {μ}_{K} ) \qquad ( 11 )$$
the threaded fastener being tightened again with a torque value expressed as
$${M}_{A}^{‵‵‵} = {F}_{M}^{‵} ( 0 , 16 \cdot p + {d}_{2} \cdot {μ}_{G} \cdot 0 , 58 + \frac{{d}_{KM}}{2} \cdot {μ}_{K} ) . \qquad ( 12 )$$

9) METHOD as claimed in any of the preceding claims, characterized in that the angles θₜ and θₜ′, are proportional, their slopes being substantially equal, the angular coefficient for the straight lines being defined by
$$\frac{{M}_{A}^{‵‵‵}}{θ {t}^{‵}} = \frac{{M}_{A}^{‵}}{θ t} , \qquad [ equation ( 15 ) ]$$
and calling
$${λ}_{1} = \frac{{M}_{A}^{‵}}{θ t} = \frac{{M}_{A}^{``}}{θ {t}^{‵}} - \qquad [ equation ( 16 ) ]$$
or making
$${λ}_{2} = \frac{θ t}{θ {t}^{‵}} \qquad [ equation ( 17 ) ]$$
it can be said that
$$\frac{{F}_{M}}{{F}_{M}^{′}} = {λ}_{2} . \qquad [ equation ( 18 ) ]$$

10) METHOD as claimed in any of the preceding claims, characterized in that the portion of the θₜ angle generated by the fastener results from the application of a torque value defined by the following equation: M_{GA}*=2·F_{M}·d₂·μ_{G}·0,58 (19)

11) METHOD as claimed in any of the preceding claims characterized in that the calculation of the friction coefficient on the thread (μ_{G}) and the clamping force load are calculated by the analysis of the torsion angles θₜ, θₜ′.

12) METHOD as claimed in any of the preceding claims characterized in that all parameters shown on graph (3), determined with the help of the friction coefficient μ_{G}, also determined in function of said parameters, are used to calculate the friction coefficient μ_{K} and also the torque coefficient designated as k, the calculated coefficients being inserted in equation (2), allowing the calculation of the torque needed to reach a previously chosen final clamping force.

13) METHOD as claimed in any of the previous claims, characterized in that the thread friction coefficient μ_{G} determined through equations (42) and (43) and the F_{M} determined through equation (6) or equation (37) and by the coefficient μ_{K} on equation (8) the coefficient on equation (2) by the F_{MF} previously chosen in order to obtain the torque M_{AF} necessary to reach F_{MF}.

14) METHOD as claimed in any of the preceding claims characterized in that the method allows the acquisition and monitoring of the parameter “angle of torsion θ” of all threaded elements individually and sequentially, without any failure or interruption of the readings, as associated to the torque and to the angle of displacement.

15) METHOD as claimed in any of the preceding claims characterized in that the parameter angle of torsion θ takes into account the various geometric features of said threaded elements as well as their shear modulus.

16) METHOD as claimed in any of the preceding claims characterized in that the method comprises the following steps, based on figure (3):
a) Initiate the tightening process using an automatic or manual spindle machine comprising means for real time simultaneous monitoring of torque and angle;
b) Tighten the threaded fastener to reach a torque M_{A} from equation (1) in order to generate the line (a); the torque M_{A} will be larger than zero and smaller than the estimated final torque that will result in the previously established clamping force;
c) Untighten the threaded fastener until a M_{A}″ torque is reached; the M_{A}″ torque will be [M_{A}″]<[M_{A}′]<[M_{A}], its magnitude being freely chosen by the operators as long as M_{A}″ is bigger than zero; during this step, the lines (b), (c), (d) and (f) will be generated;
d) Retighten the threaded fastener up to M_{A} or any other torque that reaches the line (a) smaller than M_{A}; during this process the lines (g) and (h) will be generated; the torque M_{A}′″ will be given by the intersection of line (a) and line (h).

17) METHOD as claimed in any of the preceding claims, characterized in that the data acquired through the process of the invention comprises (a) the torque M_{A}; (b) the torque Mₖ′; (c) the torque M_{A}′; (d) the torque M_{A}″; (e) the torque Mₖ″; (f) the torque M_{GA}*; (g) the torque M_{GA}**; (h) the angle θₜ; (i) the angle θₜ′; (j) the friction coefficient μ_{G}.

18) METHOD, as claimed in any of the preceding claims characterized in that the torque M_{AF} obtained for each threaded fastener will be applied on final tightening operation in order to reach a clamping force with high accuracy when on the elastic zone or in that an angle α_{F} will be obtained and applied to each threaded fastener in order to reach the clamping force with high accuracy, either on the plastic or in the elastic zone.
